(19) United States
(12) Patent Application Publication
(10) Pub. No.: US 2025/0124902 A1
(43) Pub. Date: Apr. 17, 2025

(54) MUSICAL SOUND PROCESSING APPARATUS, METHOD, AND STORAGE MEDIUM

(71) Applicant: CASIO COMPUTER CO., LTD., Tokyo (JP)

(72) Inventor: Masaru SETOGUCHI, Tokyo (JP)

(73) Assignee: CASIO COMPUTER CO., LTD., Tokyo (JP)

(21) Appl. No.: 18/913,035

(22) Filed: Oct. 11, 2024

(30) Foreign Application Priority Data
Oct. 17, 2023 (JP) 2023-178533

(51) Int. Cl. G10H 1/00

(52) U.S. Cl. CPC G10H 1/0008; G10H 2210/076; G10H 2210/391

(57) ABSTRACT

A musical sound processing apparatus is provided. The apparatus includes at least one processor and a memory including a first area. The processor sequentially reads musical sound information of music data, sequentially overwrites and store first musical sound information in the first area on a basis of a sounding timing, rewrites the first musical sound information stored in the first area to two or more pieces of first musical sound information, and gives an instruction on production of a first musical sound corresponding to all pieces of the first musical sound information stored in the first area by operating a performance operator of an electronic musical instrument.

### CROSS-REFERENCE TO RELATED APPLICATIONS

This application claims priority based on Japanese Patent Application No. 2023-178533 filed in Japan on Oct. 17, 2023, the entire contents of which are incorporated herein.

### FIELD

The disclosure of the present specification relates to a musical sound processing apparatus, a method, and a storage medium.

### BACKGROUND

A technique for assisting a user's performance operation on an electronic musical instrument is known.

### SUMMARY

A musical sound processing apparatus according to the present disclosure includes: at least one processor; and a memory including a first area, wherein the at least one processor: sequentially reads musical sound information of music data including a plurality of pieces of the musical sound information each associated with a sounding timing; sequentially overwrites and store first musical sound information in the first area on a basis of the sounding timing, in a case where the read musical sound information includes the first musical sound information; rewrites the first musical sound information stored in the first area to two or more pieces of first musical sound information, in a case where the two or more pieces of first musical sound information are read, the two or more pieces of first musical sound information being regarded as a same sounding timing; and gives an instruction on production of a first musical sound corresponding to all pieces of the first musical sound information stored in the first area by operating a performance operator of an electronic musical instrument.

### BRIEF DESCRIPTION OF THE DRAWINGS

FIG. 1 is a block diagram illustrating a configuration of a musical instrument system according to an embodiment of the present disclosure;

FIG. 2 is a diagram for explaining an outline of a musical sound processing apparatus, a method, and a program according to an embodiment of the present disclosure;

FIG. 3 is a flowchart of processing executed by a processor included in a musical sound processing apparatus in an embodiment of the present disclosure;

FIG. 4A is a subroutine of music progress processing in step S104 in FIG. 3;

FIG. 4B is a subroutine of the music progress processing in step S104 in FIG. 3;

FIG. 5 is a diagram for explaining sounding timing and muting timing;

FIG. 6A is a subroutine of performance operation processing in step S105 in FIG. 3; and

FIG. 6B is a subroutine of performance operation processing in step S105 in FIG. 3.

### DETAILED DESCRIPTION

A musical sound processing apparatus according to an embodiment of the present disclosure, and a method and a program executed by the musical sound processing apparatus as an example of a computer will be described in detail with reference to the drawings.

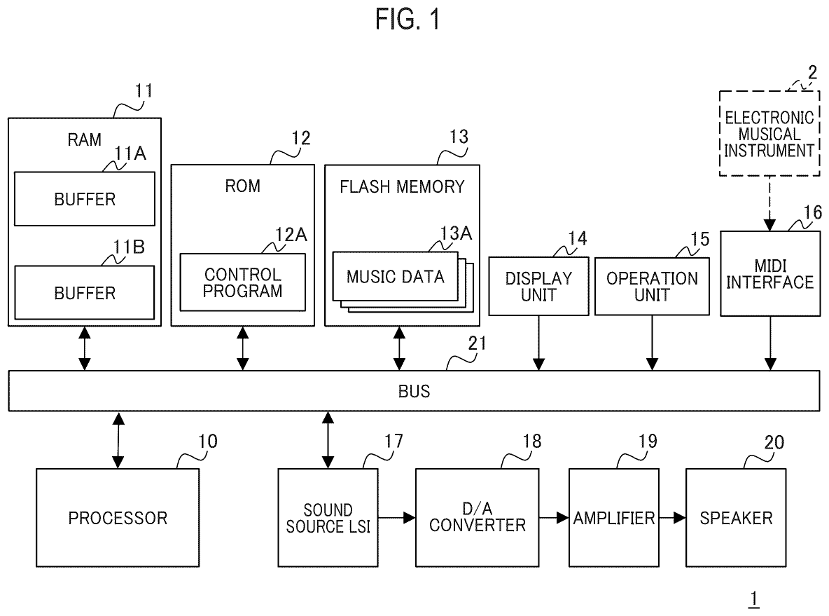

FIG. 1 is a block diagram illustrating a configuration of a musical instrument system according to an embodiment of the present disclosure. The musical instrument system according to the present embodiment includes a musical sound processing apparatus 1 and an electronic musical instrument 2. The musical sound processing apparatus 1 and the electronic musical instrument 2 are connected so as to be able to communicate with each other in a wired or radio manner.

As illustrated in FIG. 1, the musical sound processing apparatus 1 includes a processor 10, a random access memory (RAM) 11, a read only memory (ROM) 12, a flash memory 13, a display unit 14, an operation unit 15, a musical instrument digital interface (MIDI) interface 16, a sound source large scale integration (LSI) 17, a D/A converter 18, an amplifier 19, and a speaker 20. Each unit of the musical sound processing apparatus 1 is connected by a bus 21.

The processor 10 reads a program and data stored in the ROM 12. The processor 10 integrally controls the musical sound processing apparatus 1 by using the RAM 11 as a work area.

The processor 10 is, for example, a single processor or a multiprocessor, and includes at least one processor. In the case of a configuration including a plurality of processors, the processor 10 may be packaged as a single device, or may be configured by a plurality of devices physically separated in the musical sound processing apparatus 1. The processor 10 may be referred to as, for example, a control unit, a central processing unit (CPU), a micro processor unit (MPU), or a micro controller unit (MCU).

The RAM 11 temporarily holds data and a program. The RAM 11 holds, for example, various programs and various data such as music data and waveform data read from the ROM 12.

As will be described later, a partial memory area (example of a first area of the memory) of the RAM 11 is secured as a buffer 11A. Another memory area of the RAM 11 is secured as a buffer 11B. The buffer 11A and the buffer 11B may be referred to as a “sound production candidate buffer 11A” and a “sound production buffer 11B”, respectively. The buffer 11A and the buffer 11B are secured as an array region so that a plurality of note numbers constituting a chord can be stored.

The ROM 12 stores a control program 12A. When the processor 10 executes the control program 12A, various processes according to an embodiment of the present disclosure are executed. That is, the musical sound processing apparatus 1 is an example of a computer that executes various processes according to the present embodiment.

The flash memory 13 stores a plurality of pieces of music data 13A. Note that the plurality of pieces of music data 13A are pieces of data of different pieces of music, but the same reference numeral 13A is given for convenience.

The music data 13A is created in, for example, an SMF (Standard MIDI File) format. The music data 13A includes a plurality of events. A delta time, a command type, command data, and the like are described in the event.

That is, the music data 13A includes a plurality of events (example of musical sound information) associated with sounding timings.

The command type is information such as note on, note off, control change, pitch bend change, and expression. In the MIDI standard, it is referred to as a status byte.

The command data is command setting information indicated by the command type. The command data is information such as a note number and velocity. In the MIDI standard, it is referred to as a data byte.

The processor 10 sequentially reads the events in the music data 13A and progresses the song according to the delta time described in each event.

The music data 13A is not limited to data stored in the flash memory 13. The music data 13A may be acquired, for example, via a universal serial bus (USB) memory, via the Internet, via a smartphone, or the like.

The display unit 14 includes, for example, a liquid crystal display (LCD) and an LCD controller. When the LCD controller drives the LCD according to a control signal from the processor 10, a screen corresponding to the control signal is displayed on the LCD. The LCD may include a touch panel display. The LCD may be replaced with an organic electro luminescence (EL), a light emitting diode (LED), or the like.

The operation unit 15 includes a plurality of switches, buttons, and the like for the user to perform various operations. The operation unit 15 includes, for example, a power switch, a volume knob, a button for the user to select a song, a button for the user to select a performance part, a button for the user to give an instruction to start playback of a song, a button for the user to give an instruction to stop playback of a song, and the like.

The MIDI interface 16 communicably connects the musical sound processing apparatus 1 and the electronic musical instrument 2. For example, MIDI data output from the electronic musical instrument 2 is input to the MIDI interface 16.

For example, waveform data is stored in the ROM 12. The waveform data is loaded into the RAM 11 at the time of the start processing of the musical sound processing apparatus 1 so that the musical sound is quickly produced according to the music data 13A. The processor 10 instructs a sound source LSI 17 to read the corresponding waveform data from the waveform data loaded in the RAM 11.

The sound source LSI 17 generates a musical sound based on the waveform data read from the RAM 11 under an instruction of the processor 10. The sound source LSI 17 includes a plurality of generator sections, and can simultaneously produce musical sounds up to the number of generator sections. In the present embodiment, the processor 10 and the sound source LSI 17 are configured as separate processors, but in another embodiment, the processor 10 and the sound source LSI 17 may be configured as one processor.

Digital musical sound data generated by the sound source LSI 17 is converted into an analog signal by the D/A converter 18, then amplified by the amplifier 19, and output to the speaker 20.

The musical sound processing apparatus 1 is an apparatus dedicated to an electronic musical instrument including a sound source and a speaker. The musical sound processing apparatus 1 may be replaced with, for example, a smartphone, a tablet terminal, a personal computer (PC), a game controller, or the like. For example, a smartphone or a tablet terminal can operate as the musical sound processing apparatus 1 by downloading and installing an application that executes various processes according to an embodiment of the present disclosure from an app store. In this case, for example, the user can operate the musical sound processing apparatus 1 by performing a touch operation on a graphical user interface (GUI) screen on which various components are laid out.

The electronic musical instrument 2 is, for example, an electronic saxophone. The electronic musical instrument 2 outputs MIDI data to the musical sound processing apparatus 1 according to the user's performance operation. Hereinafter, this MIDI data is referred to as “MIDI data D”.

The MIDI data D output from the electronic musical instrument 2 includes, for example, various messages such as note on, note off, pitch bend, and control change (for example, expression). The pitch bend message is issued, for example, on the basis of the strength of the force of the user who bites the blowing port of the electronic musical instrument 2. The expression message is issued, for example, on the basis of the strength of the user's blowing of the electronic musical instrument 2.

The electronic musical instrument 2 may be another form of electronic musical instrument such as an electronic percussion instrument, an electronic wind instrument, or an electronic string instrument.

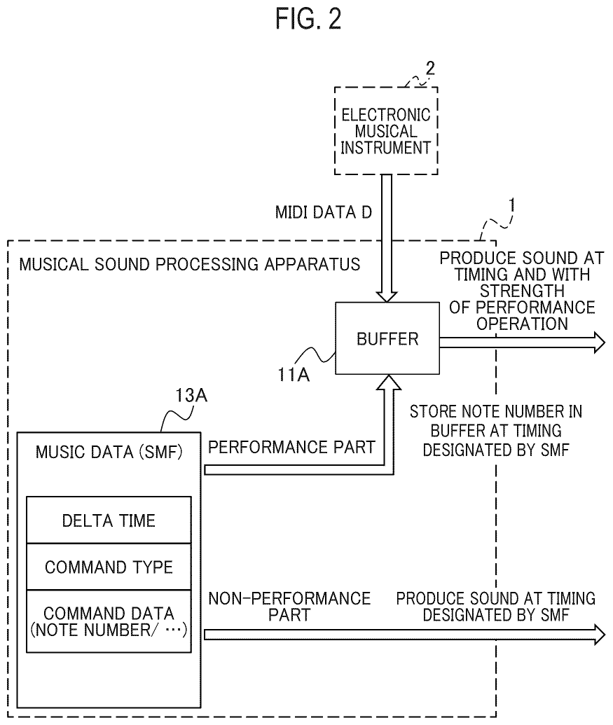

FIG. 2 is a diagram for explaining an outline of a method and a program executed by the musical sound processing apparatus 1 according to an embodiment of the present disclosure.

The SMF (that is, the music data 13A) includes one or two or more tracks and includes a plurality of parts. The user can select one performance part from the plurality of parts by operating the operation unit 15. The plurality of parts includes a melody part, a chord part, a base part, a drum part, and the like. For convenience, a part other than the performance part is described as a “non-performance part”.

The music data 13A may include one part. In this case, this one part is a performance part.

The musical sound processing apparatus 1 sequentially reads each event (MIDI data) included in the music data 13A.

At the timing specified by the SMF and the sounding timing of the musical sound of the non-performance part, the musical sound processing apparatus 1 immediately instructs the sound source LSI 17 to produce the musical sound specified in the event and causes the sound source LSI 17 to produce the musical sound. That is, the musical sound processing apparatus 1 automatically performs the musical sound of the non-performance part at the timing and the magnitude specified by the SMF.

On the other hand, at the timing specified by the SMF and the sounding timing of the musical sound of the performance part, the musical sound processing apparatus 1 does not immediately instruct the sound source LSI 17 to produce a sound and stores the note number described in the event in the buffer 11A. In the buffer 11A, the latest note number, which is a note number described in the event of the performance part, is always overwritten and stored in accordance with the progress of the song.

When the user performs a performance operation on the electronic musical instrument 2, the MIDI data D is input to the musical sound processing apparatus 1. For example, when the MIDI data D including a note-on message is input, the musical sound processing apparatus 1 instructs the sound source LSI 17 to produce the musical sound with the note number stored in the buffer 11A at that time regardless of the note number included in the MIDI data D. The magnitude of the musical sound to be produced is determined according to the velocity included in the MIDI data D, not the velocity described in the event of the music data 13A. That is, the musical sound processing apparatus 1 produces the musical sound of the performance part at the timing and magnitude of the user operation.

As described above, the musical sound processing apparatus 1 produces the musical sound of the non-performance part at the timing and the magnitude according to the music data 13A, and produces the musical sound of the performance part according to the operation timing and the strength of the operation by the user.

The user can automatically advance the music and play the musical sound of the part that the user wants to play at an arbitrary timing and magnitude while listening to the musical sound of the non-performance part. Even a user who is not good at playing a musical instrument can experience performance of a desired part through an active operation.

In another point of view, the user may not play all the parts, but may play some parts selected by the user. The user can feel as if the user performed a complicated performance by independently performing a part of the performance with a simple operation.

As the song progresses (specifically, every time the timing at which the musical sound of the performance part should be produced comes), the note number in the buffer 11A is automatically replaced. Therefore, even when the user freely plays the electronic musical instrument 2, the user can play a song with an appropriate musical sound to be produced at each time.

In the present embodiment, the electronic musical instrument 2 is an electronic saxophone-type MIDI controller (hereinafter, referred to as an “electronic saxophone”). The electronic musical instrument 2, which is an electronic saxophone, is a single-tone musical instrument. Therefore, it is difficult for the electronic musical instrument 2 to perform chord performance. For example, even in a case where the user quickly performs a blowing operation (an operation of blowing air) on the electronic musical instrument 2 a plurality of times, the sound to be produced is not a chord but a plurality of continuous sounds.

Therefore, a plurality of MIDI data D constituting a chord is not input from the electronic musical instrument 2 to the musical sound processing apparatus 1. For example, in a case where a chord is included in the performance part of the music data 13A, it has been difficult for the musical sound processing apparatus 1 to produce this chord as a chord.

Therefore, in a case where a chord is included in the performance part of the music data 13A, the musical sound processing apparatus 1 according to the present embodiment is configured to be able to produce the sound as a chord.

Specifically, the musical sound processing apparatus 1 (processor 10) sequentially reads an event (example of musical sound information) of the music data 13A including a plurality of pieces of musical sound information each associated with a sounding timing, and in a case where the read event includes a note number (example of first musical sound information that is information related to a note of a first part) of a performance part, sequentially overwrites and stores the note number of the performance part in the buffer 11A (example of the first area) on the basis of the sounding timing.

In a case where two or more note numbers having the same sounding timing are read, the musical sound processing apparatus 1 overwrites and stores the two or more note numbers in the buffer 11A (in other words, the note number stored in the buffer 11A is rewritten into two or more first note numbers having the same sound generation timing). The musical sound processing apparatus 1 gives an instruction on sound production of a musical sound (example of a first musical sound) corresponding to all note numbers stored in the buffer 11A by operating a performance operator of the electronic musical instrument 2 (for example, every time the performance operator of the electronic musical instrument 2 is operated, at an operated timing).

That is, in a case where two or more note numbers are stored in the buffer 11A, the musical sound processing apparatus 1 causes a chord corresponding to the two or more note numbers to be produced at the timing of the performance operation of the user. The user can cause the musical sound processing apparatus 1 to produce the chord included in the performance part only by performing one performance operation on the electronic musical instrument 2 (for example, by a simple operation of only making one sound once).

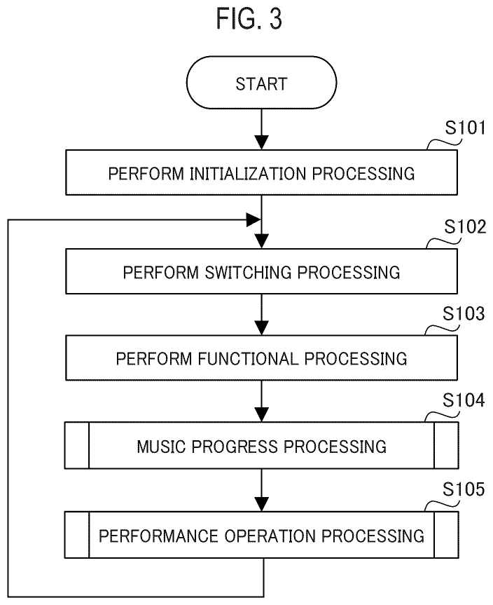

FIG. 3 is a flowchart illustrating processing executed by the processor 10 in an embodiment of the present disclosure. For example, when the musical sound processing apparatus 1 is powered on, execution of the processing illustrated in FIG. 3 is started. When the power supply of the musical sound processing apparatus 1 is turned off, the execution of the processing illustrated in FIG. 3 ends.

In the description of this flowchart, a melody part of the music data 13A is a performance part, and a part other than the melody part is a non-performance part. The melody part of the music data 13A includes a chord. In another embodiment, a part other than the melody part may be a performance part.

As illustrated in FIG. 3, the processor 10 executes initialization processing (step S101). In the initialization processing, each component is initialized. Furthermore, initialization of variables such as resetting of the buffers 11A and 11B is also performed.

The processor 10 executes switching processing (step S102). In the switching processing, the operation state of each operation member of the operation unit 15 is acquired.

The processor 10 executes functional processing (step S103). In the functional processing, a function corresponding to the operation state of each operation member acquired in step S102 is executed. For example, in a case where a music playback start button is pressed, the music playback start processing is executed. In a case where a song selection button is pressed, the selected music data 13A is loaded from the flash memory 13 to the RAM 11.

The processor 10 executes music progress processing (step S104). In the music progress processing, the music progresses as time passes.

The processor 10 executes performance operation processing (step S105). In the performance operation processing, when the MIDI data D corresponding to the performance operation of the user is input from the electronic musical instrument 2, processing corresponding to the performance operation is executed.

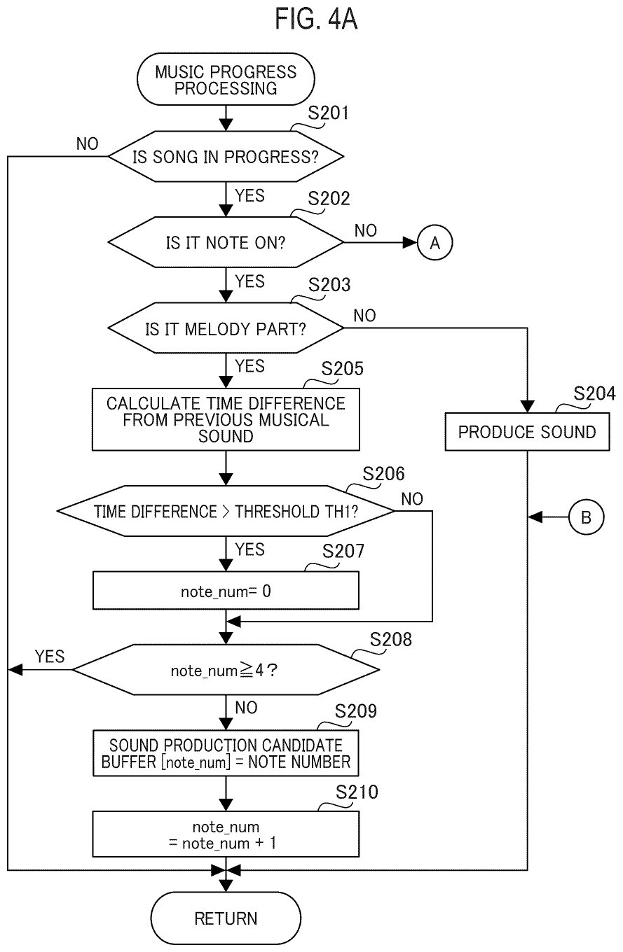

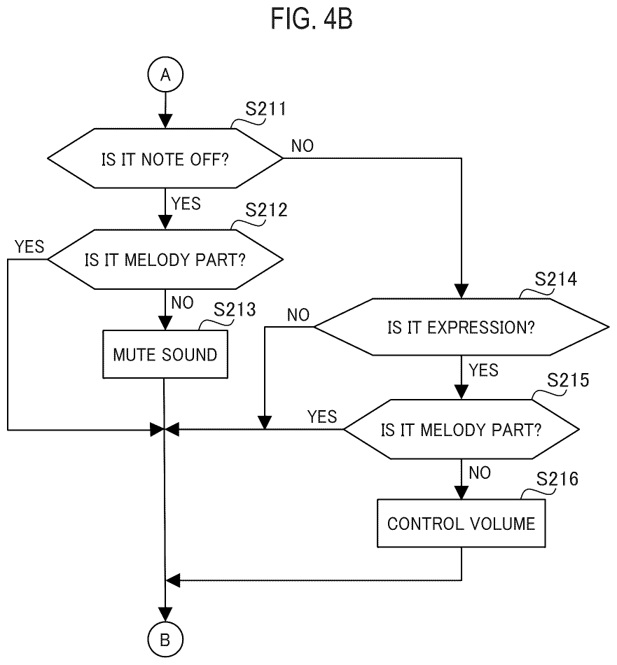

FIGS. 4A and 4B are subroutines of the music progress processing (step S104 in FIG. 3).

As illustrated in FIG. 4A, the processor 10 determines whether a song is in progress (step S201). If the user has pressed the music playback start button and has not pressed the song playback stop button or a song has not ended, the song is in progress.

In a case where the song is not in progress (step S201: NO), the processor 10 ends the subroutine of the music progress processing (step S104 in FIG. 3).

When the song is in progress (step S201: YES), the processor 10 determines whether the event of the music data 13A to be processed in the current progressing time includes the note-on message (step S202).

In a case where it is determined in step S202 that the note-on message is included (step S202: YES), the processor 10 determines whether an event including the note-on message constitutes a melody part (step S203). Hereinafter, an event including a note-on message or a note-off message is referred to as a “note event”.

In a case where the note event constitutes a non-performance part other than the melody part (step S203: NO), the processor 10 instructs the sound source LSI 17 to produce a musical sound according to the description content (note number, velocity, etc.) of the note event (step S204), and ends the subroutine of the music progress processing (step S104 in FIG. 3).

The sound source LSI 17 produces a musical sound of a non-performance part according to an instruction from the processor 10. As a result, a musical sound is output from the speaker 20.

That is, in a case where the read event (example of musical sound information) includes the note number (example of second musical sound information that is information related to a note of a second part different from the first part) of the non-performance part, the processor 10 does not store the note number in the sound production candidate buffer 11A (example of the first area), and instructs the sound source LSI 17 to produce a musical sound (example of the second musical sound) corresponding to the note number at the sounding timing of the note number.

In a case where the note event constitutes a melody part (step S203: YES), the processor 10 calculates a time difference between the sounding timings of the musical sound of the previous note event and the musical sound of the current note event with reference to the delta time included in the note event (step S205).

In a case where the time difference between the sounding timings of the musical sound of the previous note event and the musical sound of the current note event is larger than a threshold TH1 (example of the first threshold) (step S206: YES), it is difficult for a person to audibly recognize the sound as a sound produced simultaneously. Therefore, it is determined that the current musical sound is not produced at the same time as the previous musical sound.

In this case, the processor 10 resets a variable note_num to 0 (step S207). The variable note_num is a variable indicating the number of musical sounds to be simultaneously produced.

For example, the time corresponding to the 128_th notes is an extremely short time. The processor 10 regards the musical sounds of a plurality of note events having a sounding timing within this time as musical sounds (that is, chord) to be simultaneously produced. Therefore, the threshold TH1 is set to a value indicating a time corresponding to a 128_th note.

For example, for a song with a tempo of 120, the time corresponding to a quarter note is 0.5 seconds. Therefore, the time corresponding to the 128_th note is 1/32 of 0.5 seconds, that is, 15.625 milliseconds. For a song with a tempo of 60, the time corresponding to the 128_th note is 31.25 milliseconds. In this way, the time corresponding to the 128_th note varies depending on the tempo of a song. Therefore, the processor 10 changes the threshold TH1 according to the tempo of the music data 13A.

The threshold TH1 may be a value indicating a constant time regardless of the tempo. However, in this case, for example, in a song with a fast tempo, a musical sound of a note event that is better not to be simultaneously produced may be simultaneously produced. In addition, for example, in a song with a slow tempo, there is a case where a musical sound of a note event that is better to be simultaneously produced is not simultaneously produced.

In a case where the time difference between the sounding timings of the musical sound of the previous note event and the musical sound of the current note event is equal to or less than the threshold TH1 (step S206: NO), these musical sounds are regarded as musical sounds (that is, chord) to be simultaneously produced.

That is, in a case where the time difference between the sounding timings of the two or more pieces of first musical sound information is equal to or less than the first threshold (threshold TH1), the processor 10 considers that the sounding timings of the two or more pieces of first musical sound information are the same. In this case, the processor 10 proceeds to step S208 without resetting the variable note_num to 0.

In the sound production candidate buffer 11A secured as a region of the array, up to four note numbers can be stored. In order to prevent five or more note numbers from being stored in the sound production candidate buffer 11A, the processor 10 determines whether the variable note num is 4 or more (step S208).

In general, the number of musical sounds constituting a chord is 3 to 6. The chord constituting the melody part may be a maximum of four chords. Therefore, in the present embodiment, a maximum of four note numbers can be stored in the sound production candidate buffer 11A.

In another embodiment, a maximum of two or three or five or more note numbers may be stored in the sound production candidate buffer 11A. In a case where the number is five or more, for example, a tension code can be produced.

The number of musical sounds constituting a chord varies depending on the part. Therefore, the processor 10 may change the maximum number of note numbers that can be stored in the sound production candidate buffer 11A according to the performance part set by the user operation.

In a case where the variable note_num is 4 or more (step S208: YES), it is difficult to store the note number in the sound production candidate buffer 11A any more. Therefore, the processor 10 ends the subroutine of the music progress processing (step S104 in FIG. 3).

In a case where the variable note num is less than 4 (step S208: NO), the processor 10 stores the note number of the current note event in the note_num_th index of the sound production candidate buffer 11A (step S209). The note_num_th is an ordinal number associated with the index of the sound production candidate buffer 11A, and starts from the 0_th and ends at the third.

The processor 10 increases the variable note_num by 1 (step S210), and ends the subroutine of the music progress processing (step S104 in FIG. 3).

For example, in a case where the variable note_num is set to 0 in step S207, the note number is stored in the zeroth index of the sound production candidate buffer 11A in step S209. By increasing the variable note_num by 1 in step S210, both the number of stored note numbers and the value of the variable note_num become 1 and coincide with each other.

For example, in a case where note numbers are stored in the zeroth to third indexes of the sound production candidate buffer 11A, the number of stored note numbers and the value of the variable note_num are both 4 by increasing the variable note_num by 1 in step S210, and coincide with each other.

In this manner, the processor 10 manages the number of note numbers to be simultaneously sounded by using the variable note_num. In other words, the processor 10 stores the number of note numbers (example of the first musical sound information) to be overwritten and stored in the sound production candidate buffer 11A (example of the first area).

Note that the variable note_num may be fixed to 1 in a case where the chord performance is not performed at all in the melody part and the chord performance is performed in a single tone. For example, the user switches the flag on and off by a predetermined operation. When the flag is turned on, the variable note_num is fixed to 1, and only a single sound can be produced. When the flag is turned off, the fixation of the variable note_num is released, and sound production with a single tone and a chord becomes possible.

In other words, the user can switch to a mono mode by turning on the flag, and can switch to a poly mode by turning off the flag. In the mono mode, only the musical sound with the note number stored in the zeroth index of the sound production candidate buffer 11A is produced.

In a case where it is determined in step S202 that the note-on message is not included (step S202: NO), the processor 10 determines whether the event of the music data 13A to be processed in the current progressing time includes the note-off message (step S211).

In a case where it is determined that the note-off message is included (step S211: YES), the processor 10 determines whether an event including the note-off message constitutes a melody part (step S212).

In a case where the note event constitutes a non-performance part other than the melody part (step S212: NO), the processor 10 instructs the sound source LSI 17 to mute the corresponding musical sound according to the note-off message (step S213), and ends the subroutine of the music progress processing (step S104 in FIG. 3).

The sound source LSI 17 mutes the musical sound of the non-performance part according to an instruction from the processor 10.

In a case where the note event constitutes a melody part (step S212: YES), the processor 10 ignores the note-off message and ends the subroutine of the music progress processing (step S104 in FIG. 3). In other words, the processor 10 ends the subroutine of the music progress processing (step S104 in FIG. 3) without performing the muting processing according to the note-off message.

In this manner, the processor 10 does not mute the first musical sound even in a case where the note-off message corresponding to the first musical sound being produced is read from the music data 13A.

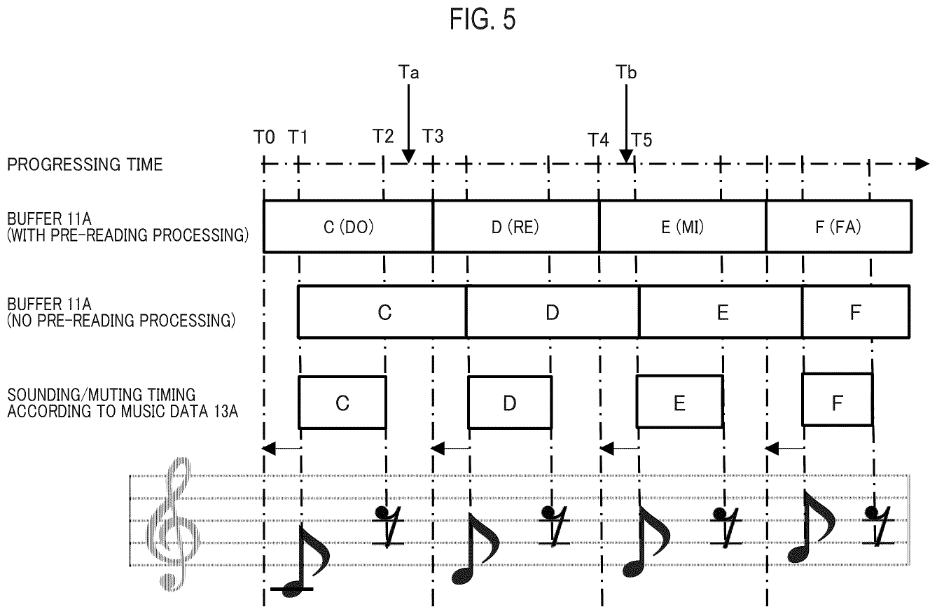

FIG. 5 is a diagram for explaining sounding timing and muting timing. In the example of FIG. 5, in a case where the music data 13A is followed, the sound production of the musical sound in a sound range C is started at a progressing time T1, and the musical sound in the sound range C is muted at a progressing time T2. That is, the sound production of the musical sound in the sound range C is started at the timing of the musical score, and is muted at the timing of the musical score. Musical sounds in other ranges are also started to be produced and muted at the timing of the musical score.

On the other hand, in the present embodiment, the note-off message is ignored for the performance part. Therefore, the sound is not muted at the timing of the musical score. As a result, the note number of the sound range C is stored in the sound production candidate buffer 11A even in a silent period (for example, between the progressing time T2 and the progressing time T3) in which there is no sound in the performance according to the musical score. As described above, in the present embodiment, ignoring the note-off message eliminates the silent period.

Therefore, for example, even in a case where the user performs a performance operation (for example, at a progressing time Ta) during a silent period, a musical sound is necessarily produced. The user can easily perform performance like arranging the original musical composition.

In the present embodiment, pre-reading processing is applied. The pre-reading processing is a process of storing the corresponding note number in the sound production candidate buffer 11A earlier than the sounding timing (in other words, according to the musical score) according to the music data 13A.

For example, in FIG. 5, a progressing time Tb is a time immediately before a progressing time T5. The progressing time T5 is a sounding timing of the musical sound in a sound range E.

As a result of the user trying to produce the musical sound in the sound range E at just timing, the user may perform a performance operation at a time (for example, the progressing time Tb) that is extremely slightly before the progressing time T5. In a case where there is no pre-reading processing, as illustrated in FIG. 5, the note number of a sound range D is stored in the sound production candidate buffer 11A at the progressing time Tb. Therefore, a musical sound in the sound range D not intended by the user is produced.

On the other hand, in a case where there is pre-reading processing, as illustrated in FIG. 5, the note number of the sound range E is stored in the sound production candidate buffer 11A at the progressing time Tb. Therefore, a musical sound in the sound range E intended by the user is produced.

In the pre-reading processing, for example, the note number is stored in the sound production candidate buffer 11A earlier than the sounding timing of the musical score by the time corresponding to a thirty-second note.

In a case where it is determined in step S211 that the note-off message is not included (step S211: NO), the processor 10 determines whether the event of the music data 13A to be processed at the current progressing time includes an expression message (step S214).

In a case where it is determined that the expression message is included (step S214: YES), the processor 10 determines whether the event including the expression message constitutes a melody part (step S215).

In a case where the event including the expression message constitutes a non-performance part other than the melody part (step S215: NO), the processor 10 instructs the sound source LSI 17 to perform volume control according to the expression message described in the event (step S216), and ends the subroutine of the music progress processing (step S104 in FIG. 3).

The sound source LSI 17 controls the volume of the non-performance part according to an instruction from the processor 10.

In a case where the event including the expression message constitutes the melody part (step S215: YES), the processor 10 ignores the expression message described in the event and ends the subroutine of the music progress processing (step S104 in FIG. 3) similarly to the note-off message. In other words, the processor 10 ends the subroutine of the music progress processing (step S104 in FIG. 3) without giving an instruction on the volume control according to the expression message.

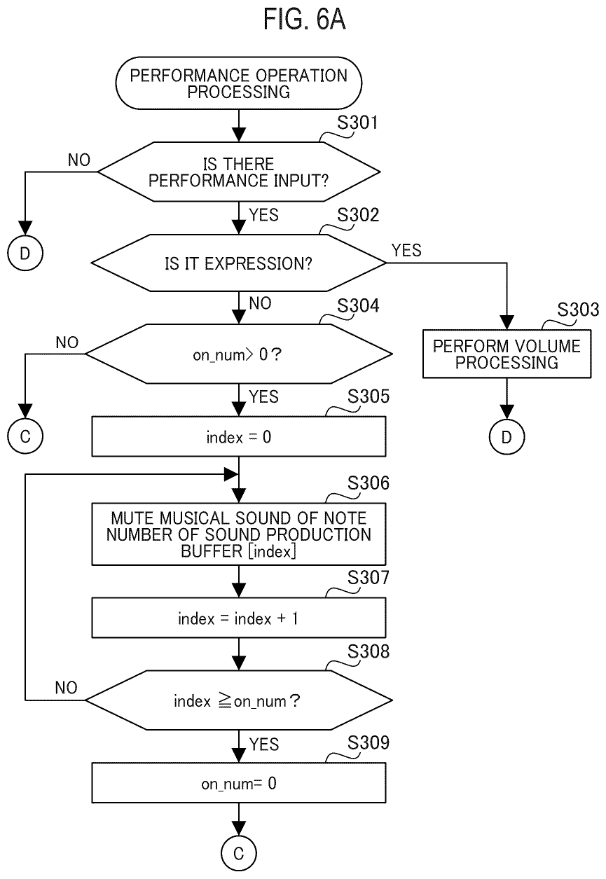

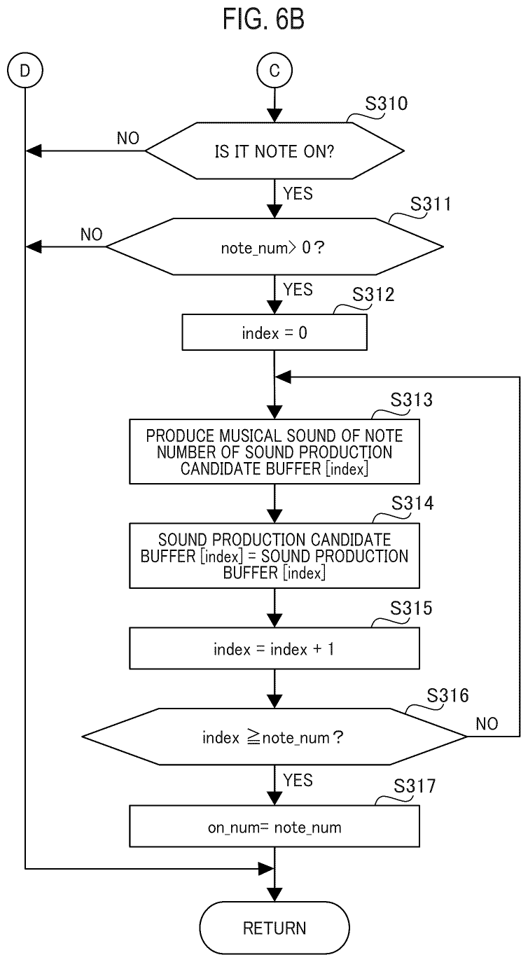

FIGS. 6A and 6B are subroutines of the performance operation processing (step S105 in FIG. 3).

As illustrated in FIG. 6A, the processor 10 determines the presence or absence of an input (performance input) from the electronic musical instrument 2 according to the performance operation of the user (step S301). In a case where there is no performance input (step S301: NO), the processor 10 ends the subroutine of the performance operation processing (step S105 in FIG. 3) without instructing the sound source LSI 17.

That is, in a case where there is no performance input (in other words, in a case where the performance operator is not operated), the processor 10 does not instruct the sound source LSI 17 to produce the musical sound (first musical sound) corresponding to the note number (example of the first musical sound information) stored in the sound production candidate buffer 11A (example of the first area).

In a case where there is a performance input (step S301: YES), the processor 10 determines whether the performance input includes an expression message (control change No. 11) (step S302).

In a case where the performance input includes the expression message (step S302: YES), the processor 10 instructs the sound source LSI 17 to perform volume control according to the message (step S303), and ends the subroutine of the performance operation processing (step S105 in FIG. 3).

The sound source LSI 17 controls the volume of a melody part in accordance with an instruction from the processor 10.

As described above, the processor 10 ignores the expression message described in the event of the melody part (see step S215), and controls the volume of the melody part according to the blowing amount of breath during the blowing operation of the electronic musical instrument 2 by the user. Therefore, the performance expression of the user is reflected in the musical sound of the melody part.

In a case where the performance input does not include the expression message (step S302: NO), the processor 10 determines whether the variable on_num is greater than 0 (step S304).

The variable on_num is a variable indicating the number of musical sounds currently being produced. In a case where the variable on_num is 1 or more, it indicates that there is a musical sound currently being produced.

Here, in the present embodiment, regardless of whether the message included in the performance input determined in step S301 is the note-on message or the note-off message, the musical sound currently being produced in the melody part is muted. Note that, since the electronic musical instrument 2 is an electronic saxophone which is a single musical instrument, the note-off operation for the musical sound being produced is always performed before the note-on operation for a new musical sound is performed. Therefore, such muting processing is not essential. On the other hand, in the case of a chord instrument such as an electronic keyboard instrument, the note-on operation may be continuous. In this case, such muting processing is effective.

In addition, a failure may occur in which the note off of a certain musical sound is not transmitted to the musical sound processing apparatus 1 due to a communication failure or the like. By performing the muting processing as described above, it is possible to avoid a problem that a musical sound continues to be produced.

In a case where the variable on_num is larger than 0 (in other words, the variable on_num is greater than or equal to 1) (step S304: YES), the processor 10 resets a variable index to 0 (step S305). The variable index is a variable that designates an index of the array.

The processor 10 instructs the sound source LSI 17 to mute the musical sound of the note number which is an element of the sound production buffer 11B stored in the index designated by the variable index (step S306).

The sound production buffer 11B is an array in which the note number of the musical sound currently being produced is stored. In the sound production buffer 11B, the note number of the musical sound currently being produced is stored in the index designated by the variable index.

The processor 10 increases the variable index by 1 (step S307).

The processor 10 determines whether the variable index is equal to or larger than the variable on_num (that is, the number of musical sounds currently being produced) (step S308). If the variable index is smaller than the variable on_num (step S308: NO), the processor 10 returns to step S306.

The processor 10 repeats steps S306 to S308 until the variable index and the variable on num become the same (step S308: YES). As a result, the sound source LSI 17 is instructed to mute all musical sounds currently being produced in the melody part.

In response to an instruction from the processor 10, the sound source LSI 17 mutes all the musical sounds currently being produced in the melody part.

Since all the musical sounds being produced in the melody part are muted, the processor 10 resets the variable on_num to 0 (step S309).

In a case where the variable on_num is 0 in step S304 (step S304: NO) or after the variable on_num is reset to 0 in step S309, the processor 10 determines whether the performance input determined in step S301 includes the note-on message (step S310).

In a case where the performance input determined in step S301 includes the note-off message (step S310: NO), there is no musical sound to be muted, or the muting processing has already been performed. Therefore, the processor 10 ends the subroutine of the performance operation processing (step S105 in FIG. 3).

In a case where the performance input determined in step S301 includes the note-on message (step S310: YES), the processor 10 determines whether the variable note_num (that is, the number of note numbers stored in the sound production candidate buffer 11A) is larger than 0 (step S311).

In a case where the variable note_num is 0 (step S311: NO), there is no musical sound to be produced. Therefore, the processor 10 ends the subroutine of the performance operation processing (step S105 in FIG. 3).

In a case where the variable note_num is larger than 0 (in other words, the variable note_num is greater than or equal to 1) (step S311: YES), a musical sound to be produced is stored in the sound production candidate buffer 11A. Therefore, in the subsequent processing, the processor 10 instructs the sound source LSI 17 to produce the musical sounds of all the note numbers stored in the sound production candidate buffer 11A.

Specifically, the processor 10 resets the variable index to 0 (step S312).

The processor 10 instructs the sound source LSI 17 to produce the musical sound of the note number, which is the element of the sound production candidate buffer 11A, stored in the index specified by the variable index (step S313). More specifically, the processor 10 instructs the sound source LSI 17 to produce a musical sound with a magnitude corresponding to the velocity of the performance input determined in step S301.

The processor 10 stores the note number of the musical sound, on which an instruction is given to be produced, in the index of the sound production buffer 11B designated by the variable index (step S314).

The processor 10 increases the variable index by 1 (step S315).

The processor 10 determines whether the variable index is equal to or larger than the variable note_num (that is, the number of note numbers stored in the sound production candidate buffer 11A) (step S316). When the variable index is smaller than the variable note_num (step S316: NO), the processor 10 returns to step S313.

The processor 10 repeats steps S313 to S316 until the variable index and the variable note num become the same (step S316: YES). As a result, the musical sounds of all the note numbers stored in the sound production candidate buffer 11A are simultaneously produced as chords, and the note numbers of all the produced musical sounds are stored in the sound production buffer 11B.

As described above, every time the user makes a performance input to the electronic musical instrument 2, the processor 10 instructs the sound source LSI 17 to produce a musical sound (first musical sound) corresponding to all note numbers (example of first musical sound information) stored in the sound production candidate buffer 11A (example of the first area) at the operation timing.

In addition, every time there is a user's performance input to the electronic musical instrument 2, the processor 10 acquires the number (that is, the variable note_num) of note numbers (example of first musical sound information) to be overwritten and stored in the sound production candidate buffer 11A (example of the first area) at the operation timing, and instructs the sound source LSI 17 to produce the acquired number of musical sounds (first musical sounds).

The processor 10 copies the value of the variable note_num (that is, the number of note numbers stored in the sound production candidate buffer 11A) to the variable on_num (that is, the number of musical sounds currently being produced) (step S317). As a result, the processor 10 can grasp the number of musical sounds being produced in the melody part by referring to the variable on_num. Therefore, in steps S306 to S308, the musical sound currently being produced in the melody part can be subjected to the muting processing.

The processor 10 performs sound producing processing of the musical sound of a note number (if there is one note number, it is a single tone, and if there are two or more note numbers, it is a chord) stored in the sound production candidate buffer 11A at a timing and with a magnitude corresponding to one user's note-on operation (for example, one breath on the electronic musical instrument 2). The user can play a song including a chord only by repeating the same note-on operation without worrying about the pitch.

The user can automatically make the music progress and play the musical sound of the part (performance part) that the user wants to play at an arbitrary timing and in an arbitrary magnitude while listening to other parts (non-performance parts). Even a user who is not good at playing a musical instrument can experience performance of a desired part through an active operation.

For example, as illustrated in FIG. 5, on the music data 13A, a musical sound in the sound range C is produced only once between the progressing time T1 and the progressing time T2. However, in the present embodiment, by performing the note-on operation a plurality of times between the progressing time T1 and the progressing time T2, the user can cause the musical sound in the sound range C to be produced a plurality of times.

In this manner, the user can play the performance part by freely and easily determining not only the sounding timing and the magnitude of the sound production but also the number of times of sound production.

In addition, the present disclosure is not limited to the above-described embodiments, and various modifications can be made in the implementation stage without departing from the gist thereof. Furthermore, the functions executed in the above-described embodiments may be appropriately combined and implemented as much as possible. The above-described embodiments include various stages, and various inventions can be extracted by appropriate combinations of a plurality of disclosed constituent elements. For example, even if some components are deleted from all the components shown in the embodiment, if an effect can be obtained, a configuration from which the components are deleted can be extracted as an invention.

In the above embodiment, the mode in which the music automatically progresses regardless of the presence or absence of the performance operation of the user has been described, but the mode applicable to the musical sound processing apparatus, the method, and the program according to the present embodiment is not limited thereto.

In another embodiment, a mode (in other words, a mode in which the music does not progress unless the user performs the playing operation) in which the music progresses only when the user performs the performance operation may be applied to the musical sound processing apparatus, the method, and the program according to the present embodiment. Even in this mode, if a plurality of note numbers constituting the chord are stored in the sound production candidate buffer 11A, the chord is generated by only one note-on operation of the user.

In the above embodiment, processing is performed on the expression message, but in another embodiment, processing may be performed on another performance expression message (pitch bend message, control change other than expression, etc.) instead of or in addition to the expression message.

Also in this case, similarly to the expression message, the processor 10 ignores the performance expression message (pitch bend message or the like) described in the event of the music data 13A. Only when a performance expression message (such as a pitch bend message) corresponding to a user operation is input from the electronic musical instrument 2, the processor 10 outputs an instruction corresponding to the message to the sound source LSI 17. Therefore, the user can add various performance expressions to the musical composition.

According to an embodiment of the present invention, a musical sound processing apparatus, a method, and a storage medium capable of allowing a user to easily perform chord performance are provided.

What is claimed is:

1. A musical sound processing apparatus comprising:
at least one processor; and
a memory including a first area, wherein
the at least one processor:
sequentially reads musical sound information of music data including a plurality of pieces of the musical sound information each associated with a sounding timing;
sequentially overwrites and store first musical sound information in the first area on a basis of the sounding timing, in a case where the read musical sound information includes the first musical sound information;
rewrites the first musical sound information stored in the first area to two or more pieces of first musical sound information, in a case where the two or more pieces of first musical sound information are read, the two or more pieces of first musical sound information being regarded as a same sounding timing; and
gives an instruction on production of a first musical sound corresponding to all pieces of the first musical sound information stored in the first area by operating a performance operator of an electronic musical instrument.

2. The musical sound processing apparatus according to claim 1, wherein
the at least one processor regards the sounding timings of the two or more pieces of first musical sound information as a same, in a case where a time difference between the sounding timings of the two or more pieces of first musical sound information is equal to or less than a first threshold.

3. The musical sound processing apparatus according to claim 2, wherein
the at least one processor changes the first threshold in accordance with a tempo of the music data.

4. The musical sound processing apparatus according to claim 1, wherein
the at least one processor:
stores a number of pieces of the first musical sound information to be overwritten and stored in the first area;
acquires the number at the operated timing; and
gives an instruction on production of the first musical sound according to the acquired number of pieces of the first musical sound information stored in the first area.

5. The musical sound processing apparatus according to claim 1, wherein
the at least one processor does not give an instruction on production of the first musical sound according to the first musical sound information stored in the first area in a case where the performance operator is not operated.

6. The musical sound processing apparatus according to claim 1, wherein
the at least one processor does not mute the first musical sound even in a case where a note-off message corresponding to the first musical sound being produced is read from the music data.

7. The musical sound processing apparatus according to claim 1, wherein
the music data includes the first musical sound information and second musical sound information,
the first musical sound information is information related to a note of a first part,
the second musical sound information is information related to a note of a second part different from the first part, and
the at least one processor gives an instruction on production of a second musical sound according to the second musical sound information at the sounding timing of the second musical sound information without saving the second musical sound information in the first area, in a case where the read musical sound information includes the second musical sound information.

8. The musical sound processing apparatus according to claim 1, wherein
the first musical sound information is a note number.

9. A method causing a computer to execute:
sequentially reading musical sound information of music data including a plurality of pieces of musical sound information each associated with a sounding timing;
sequentially overwriting and storing first musical sound information in a first area of a memory on a basis of the sounding timing, in a case where the read musical sound information includes the first musical sound information;
rewriting the first musical sound information stored in the first area to two or more pieces of first musical sound information, in a case where the two or more pieces of first musical sound information are read, the two or more pieces of first musical sound information being regarded as a same sounding timing; and
giving an instruction on production of a first musical sound corresponding to all pieces of the first musical sound information stored in the first area by operating a performance operator of an electronic musical instrument.

10. A non-transitory recording medium that stores a program causing a computer to execute:
sequentially reading musical sound information of music data including a plurality of pieces of musical sound information each associated with a sounding timing;
sequentially overwriting and storing first musical sound information in a first area of a memory on a basis of the sounding timing, in a case where the read musical sound information includes the first musical sound information;
rewriting the first musical sound information stored in the first area to two or more pieces of first musical sound information in a case where the two or more pieces of first musical sound information are read, the two or more pieces of first musical sound information being regarded as a same sounding timing; and
giving an instruction on production of a first musical sound corresponding to all pieces of the first musical sound information stored in the first area by operating a performance operator of an electronic musical instrument.
